(19) United States
(12) Patent Application Publication
(10) Pub. No.: US 2024/0111519 A1
(43) Pub. Date: Apr. 4, 2024

(54) ONBOARD COMMUNICATION SYSTEM, CENTER DEVICE, VEHICLE-SIDE SYSTEM, AND METHOD FOR VERIFYING UPDATE DATA OF ONBOARD COMMUNICATION

(71) Applicant: DENSO CORPORATION, Kariya-city (JP)

(72) Inventors: Koto TOMATSU, Kariya-city (JP); Hideo YOSHIMI, Kariya-city (JP); Masaaki ABE, Kariya-city (JP)

(21) Appl. No.: 18/537,350

(22) Filed: Dec. 12, 2023

Related U.S. Application Data
(63) Continuation of application No. PCT/JP2022/022159, filed on May 31, 2022.

(30) Foreign Application Priority Data
Jun. 29, 2021 (JP) 2021-107834

(51) Int. Cl. G06F 8/654; H04L 9/32

(52) U.S. Cl. CPC G06F 8/654; H04L 9/3239; H04L 2209/80; H04L 2209/84

(57) ABSTRACT

An onboard communication system includes a center device that transmits update data as a distribution package by a streaming manner to an electronic control unit installed in a vehicle, a master device that is installed in the vehicle and receives the distribution package and transfer the update data to the electronic control unit, and the electronic control unit that writes the update data transferred from the master device to a storage unit. The center device also transmits a hash value calculated for the update data to the master device. The electronic control unit calculates a hash value for the update data and transmits the hash value to the master device. The master device compares the hash value transmitted from the center device with the hash value transmitted from the electronic control unit to verify integrity of the update data.

### CROSS REFERENCE TO RELATED APPLICATIONS

The present application is a continuation application of International Patent Application No. PCT/JP2022/022159 filed on May 31, 2022 which designated the U.S. and claims the benefit of priority from Japanese Patent Application No. 2021-107834 filed on Jun. 29, 2021. The entire disclosures of the above application are incorporated herein by reference.

### TECHNICAL FIELD

The present disclosure relates to an onboard communication system including a center device to stream a distribution package containing update data to be written to an electronic control unit installed in a vehicle and a master device to receive the distribution package and transfer the update data to the electronic control unit; the center device and a vehicle-side system used for the system; and a method for verifying onboard communication update data.

### BACKGROUND

A related art discloses the technology in which a server delivers data packages including ECU update programs to in-vehicle devices based on OTA (Over The Air) and the vehicle rewrites the update programs.

### SUMMARY

According to one example, an onboard communication system includes a center device that is configured to transmit update data as a distribution package by a streaming manner to an electronic control unit installed in a vehicle, a master device that is installed in the vehicle and is configured to receive the distribution package and transfer the update data to the electronic control unit, and the electronic control unit that is configured to write the update data transferred from the master device to a storage unit. The center device also transmits a hash value calculated for the update data to the master device. The electronic control unit calculates a hash value for the update data and transmits the hash value to the master device. The master device compares the hash value transmitted from the center device with the hash value transmitted from the electronic control unit to verify integrity of the update data.

### BRIEF DESCRIPTION OF DRAWINGS

The above and other objects, features, and advantages of the present disclosure will become more apparent from the following detailed description made by reference to the accompanying drawings. In the drawings:

FIG. 1 is a function block diagram schematically showing the configuration of the onboard communication system according to a first embodiment;

FIG. 2 is a diagram illustrating an example of reprogramming policy metadata;

FIG. 3 is a diagram illustrating an example of download metadata;

FIG. 4 is a diagram illustrating a mode in which a distribution package is streamed from an OTA center to an in-vehicle system;

FIG. 5 is a flowchart illustrating a package generation process performed at the OTA center;

FIG. 6 is a flowchart illustrating a signature generation process at the OTA center;

FIG. 7 is a flowchart illustrating a signature transmission process at the OTA center;

FIG. 8 is a flowchart illustrating a package and signature reception process performed by an OTA master;

FIG. 9 is a flowchart illustrating a process on a target ECU;

FIG. 10 is a diagram comparable to FIG. 4 when a single target ECU is used;

FIG. 11 is a diagram illustrating a mode of transmitting a distribution package through the use of a hash chain according to a second embodiment;

FIG. 12 is a flowchart illustrating the signature generation process performed by the OTA center;

FIG. 13 is a flowchart illustrating a process on the OTA master;

FIG. 14 is a diagram illustrating a mode in which the OTA master calculates a hash value during the transmission of a distribution package according to a third embodiment;

FIG. 15 is a flowchart illustrating a process on the OTA master;

FIG. 16 is a flowchart illustrating a process on the target ECU;

FIG. 17 is a diagram illustrating a mode of transmitting a distribution package based on a mixture of a streaming manner and a storage manner according to a fourth embodiment;

FIG. 18 is a flowchart illustrating a process on the OTA master;

FIG. 19 is a diagram illustrating a mode of transmitting a distribution package via a smartphone according to a fifth embodiment;

FIG. 20 is a flowchart illustrating a process on the OTA center;

FIG. 21 is a flowchart illustrating a process on the smartphone; and

FIG. 22 is a flowchart illustrating a process on the OTA master.

### DETAILED DESCRIPTION

In recent years, there has been an increase in the scale of application programs for vehicle control and diagnosis installed in electronic control units (ECUs) for vehicles along with diversified vehicle controls such as driving support functions and automatic driving functions. There has been also an increase in chances of reprogramming to rewrite ECU application programs due to version upgrades such as function improvements. For example, the development of communication networks also promotes connected car technologies. Under these circumstances, for example, a related art discloses the technology in which a server delivers data packages including ECU update programs to in-vehicle devices based on OTA (Over The Air) and the vehicle rewrites the update programs.

The update program is rewritten according to a storage manner and a streaming manner. The storage manner downloads all update programs from the center device to the vehicle memory and then performs updates. The streaming manner performs updates while downloading update programs from the center device to the vehicle. The vehicle includes an OTA master that has a unit generally called DCM (Data Communication Module) or CGW (Central Gate Way), for example. The OTA master receives a distribution package containing an update program from the center device and transfers and writes the update program to a target ECU to be updated.

The storage manner attaches a digital signature to the distribution package. The OTA master uses the digital signature to verify the integrity of the distribution package and then writes the update program to the target ECU.

However, the streaming manner directly writes the received update program to the target ECU while the OTA master does not check integrity unlike the above. Invalid data may be directly written to the target ECU if the data of the program contained in the distribution package is replaced during a data transfer path from the center device to the target ECU.

The present disclosure has been made in consideration of the foregoing. It is therefore an object of the disclosure to provide an onboard communication system, a center device, a vehicle-side system, and a method for verifying onboard communication update data capable of verifying the integrity of update data streamed from the center device.

According to one aspect of the present disclosure, an onboard communication system comprises: a center device that is configured to transmit update data as a distribution package by a streaming manner to an electronic control unit installed in a vehicle; a master device that is installed in the vehicle and is configured to receive the distribution package and transfer the update data to the electronic control unit; and the electronic control unit that is configured to write the update data transferred from the master device to a storage unit. The center device also transmits a hash value calculated for the update data to the master device. The electronic control unit calculates a hash value for the update data and transmits the hash value to the master device. The master device compares the hash value transmitted from the center device with the hash value transmitted from the electronic control unit to verify integrity of the update data.

According to this configuration, the master device performs verification using hash values even if the update data contained in the distribution package streamed from the center device to the vehicle may be falsified and changed to incomplete data, for example. It is possible to prevent incomplete update data from being installed on the electronic control unit. It is possible to improve the security of communication systems.

According to another aspect of the present disclosure, the center device transmits a plurality of hash values calculated for each update data to the master device when a plurality of update data is respectively written to a plurality of electronic control units. The master device transfers each of the update data to each of the electronic control units. Each of the electronic control units calculates a hash value for the update data and transmits the hash value to the master device. The master device compares each of the hash values transmitted from the electronic control units with the corresponding hash value transmitted from the center device. Therefore, similarly in a case where a plurality of update data are transmitted to a plurality of electronic control units respectively, it is possible to prevent incomplete update data from being installed in each electronic control unit.

According to another aspect of the present disclosure, an onboard communication system comprises a center device that is configured to transmit update data as a distribution package by a streaming manner to an electronic control unit installed in a vehicle, a master device that is configured to receive the distribution package and transfer the update data to the electronic control unit, and the electronic control unit that is configured to write the update data transferred from the master device to a storage unit. The center device also transmits a hash value calculated for the update data to the master device. The master device calculates a hash value for each predetermined data size for the update data to obtain a hash value for a whole update data, and compares the hash value with the hash value transmitted from the center device to verify integrity of the update data.

### First Embodiment

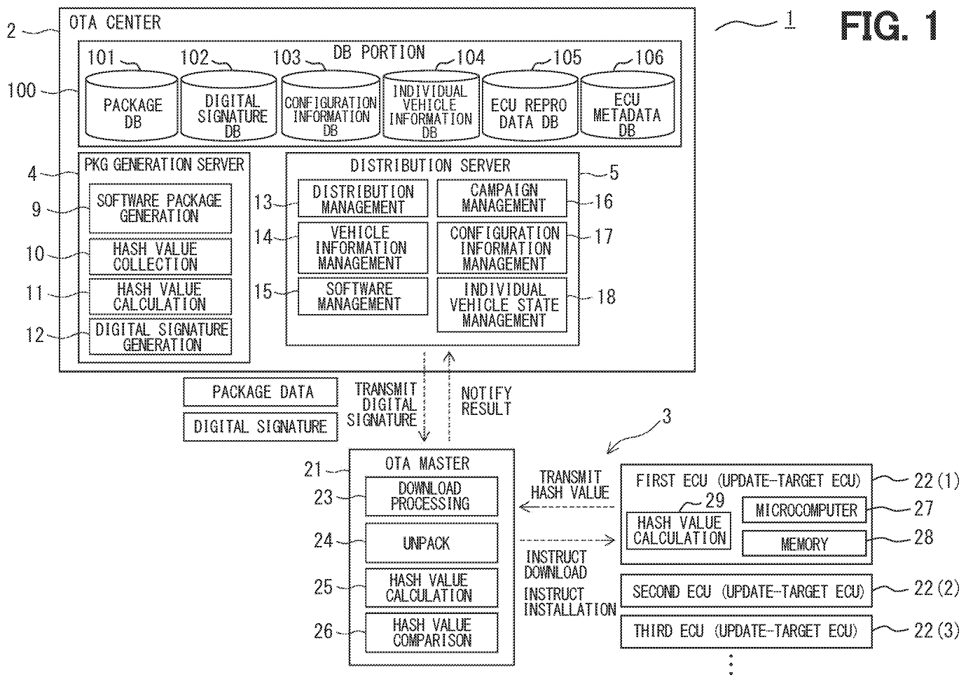

As illustrated in FIG. 1, an onboard communication system 1 according to the present embodiment includes an OTA center 2, comparable to a center device, and a vehicle-side system 3. The OTA center 2 includes a PKG generation server 4, a distribution server 5, and a DB portion 100. The DB portion 100 includes a software package DB 101, a digital signature DB 102, a configuration information DB 103, a vehicle information DB 104, ECU reprogramming data DB 105, and an ECU metadata DB 106. Hereinafter, “database” may be denoted as DB, and “package” may be denoted as PKG.

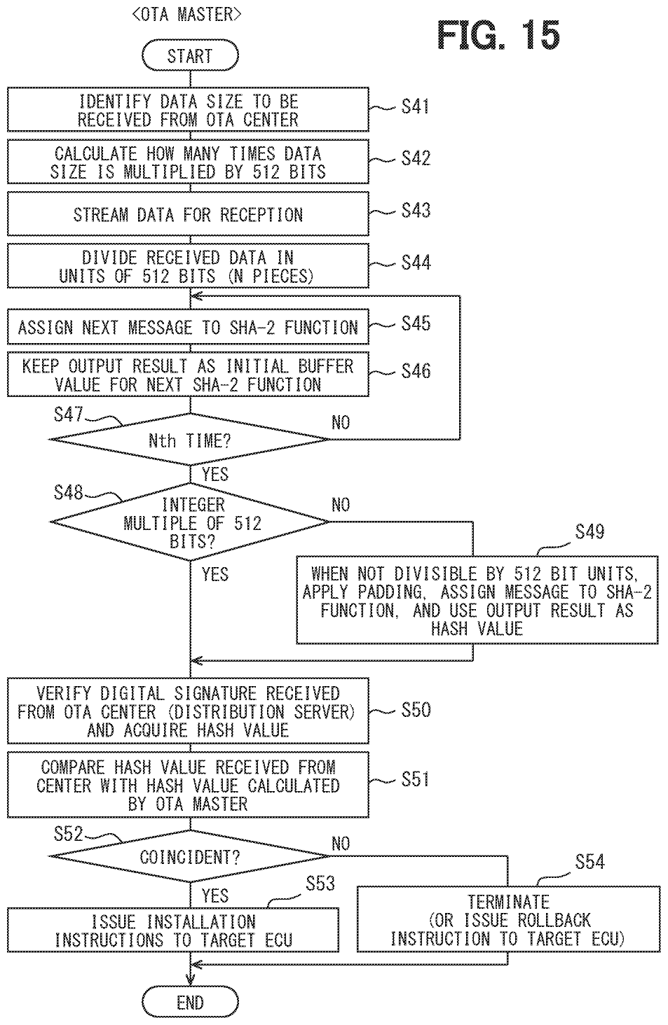

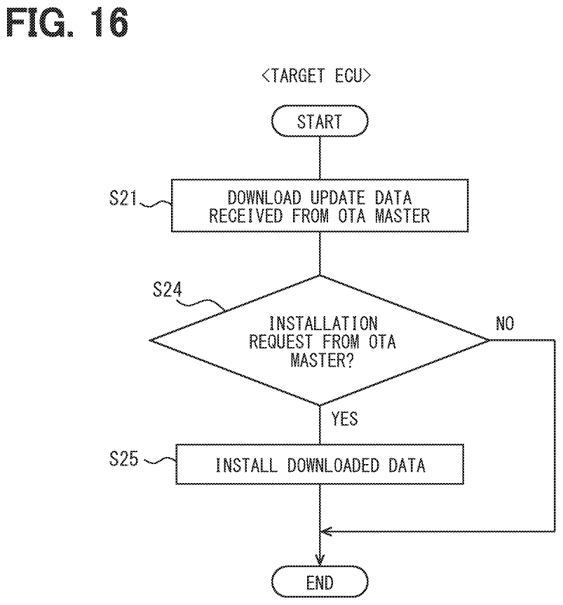

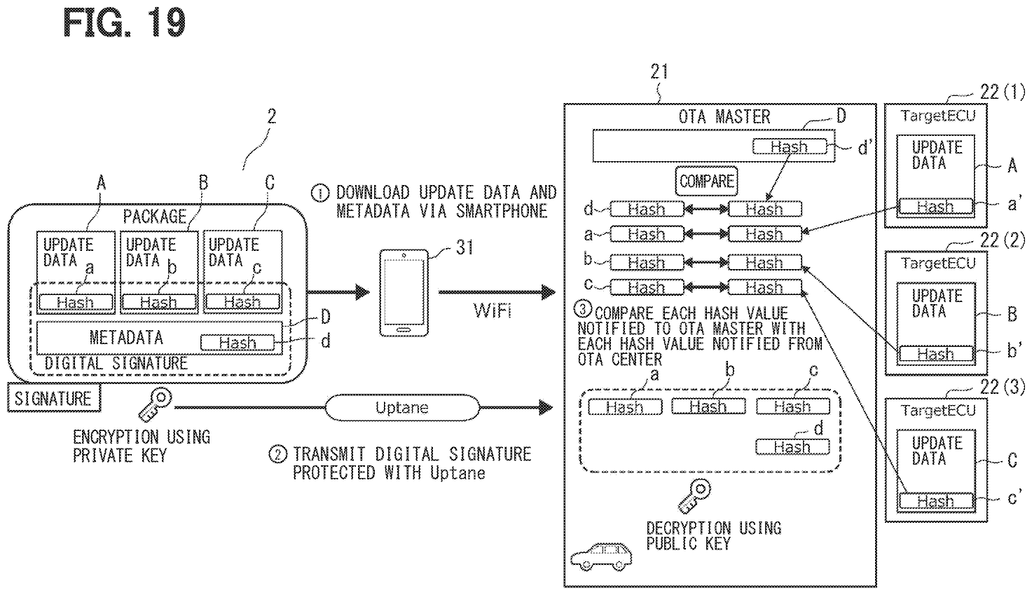

The PKG generation server 4 includes a software package generation portion 9, a hash value collection portion 10, a hash value calculation portion 11, and a digital signature generation portion 12. The software package generation portion 9 is a functional portion that generates a software package to be distributed to a vehicle equipped with a target ECU whose data is to be updated. The details are disclosed in FIG. 15, FIG. 16, and FIG. 19 of JP 2020-27624 A, for example. Hereinafter, J P 2020-27624 A is denoted as a “reference patent publication.” The software package contains update data or rewrite specification data for programs, for example. The software package DB 101 stores a software package containing hash values. The contents of JP 2020-27624 A are incorporated by reference as descriptions of technical elements in this specification.

The hash value collection portion 10 is a functional portion that collects update data used to calculate a hash value from the software package. The hash value calculation portion 11 is a functional portion that applies a hash function to the collected data to calculate a hash value. The digital signature generation portion 12 is a functional portion that adds a generated digital signature to hash value concatenation information that associates the calculated hash value with a target ID, namely, the ID of a corresponding target ECU. The digital signature is stored in the digital signature DB 102.

The distribution server 5 includes a distribution management portion 13, a vehicle information management portion 14, a software management portion 15, a campaign management portion 16, a configuration information management portion 17, and an individual vehicle state management portion 18. The distribution management portion 13 is a functional portion that manages the distribution of software packages and campaign information to each vehicle. The vehicle information management portion 14 registers and manages individual vehicle information, uploaded from individual vehicles, in the individual vehicle information DB 104. An OEM (Original Equipment Manufacturer), for example, registers an update program for the target ECU to the software management portion 15. For example, the OEM registers the campaign information to the campaign management portion 16. The campaign information is mainly related to program updates displayed in the vehicle-side system 3.

The configuration information management portion 17 manages configuration information for each vehicle type registered to the configuration information DB 103. The configuration information is identification information concerning the hardware and the software of the ECU installed in the vehicle. The configuration information also includes identification information on a system configuration composed of multiple ECUs and identification information on a vehicle configuration composed of multiple systems. The individual vehicle state management portion 18 manages information such as program update states and versions of the target ECU in each vehicle. The PKG generation server 4 and the distribution server 5 are functions implemented by the computer hardware and software.

The configuration information DB 103, the individual vehicle information DB 104, the ECU reprogramming data DB 105, and the ECU metadata DB 106 of the DB portion 100 correspond to “the configuration information DB 208, the individual vehicle information DB213, the ECU reprogramming data DB 204, and the ECU metadata DB 205” in the reference patent publication.

The vehicle-side system 3 includes an OTA master 21 comparable to a master device and update-target ECUs 22 (1), 22 (2), 22 (3), and so on, namely, electronic control units whose programs are to be updated. Hereinafter, the update-target ECU 22 is referred to as the target ECU 22.

The OTA master 21 is a functional portion as a combination of the DCM and the CGW illustrated in FIG. 1 of the reference patent publication. The OTA master 21 includes a download processing portion 23, an unpack processing portion 24, a hash value calculation portion 25, and a hash value comparison portion 26. The download processing portion 23 performs wireless communication with the OTA center 2 and downloads distribution package data and digital signature data. The unpack processing portion 24 performs an unpack process that separates the downloaded distribution package into each data section used for corresponding processes. The hash value calculation portion 25 calculates a hash value for the data value to be calculated for the hash value. This functional portion is used in the second embodiment. As described later, the hash value comparison portion 26 compares the hash value calculated in the target ECU 22 side with the hash value contained in the downloaded distribution package.

The target ECU 22 includes a microcomputer 27, memory 28, and a hash value calculation portion 29. The memory 28 is available as flash memory, for example. The update data downloaded by the OTA master 21 is transferred to and installed in the memory 28. The hash value calculation portion 29 calculates a hash value for the update data transferred from the OTA master 21.

<<Reprogramming Policy Metadata>>

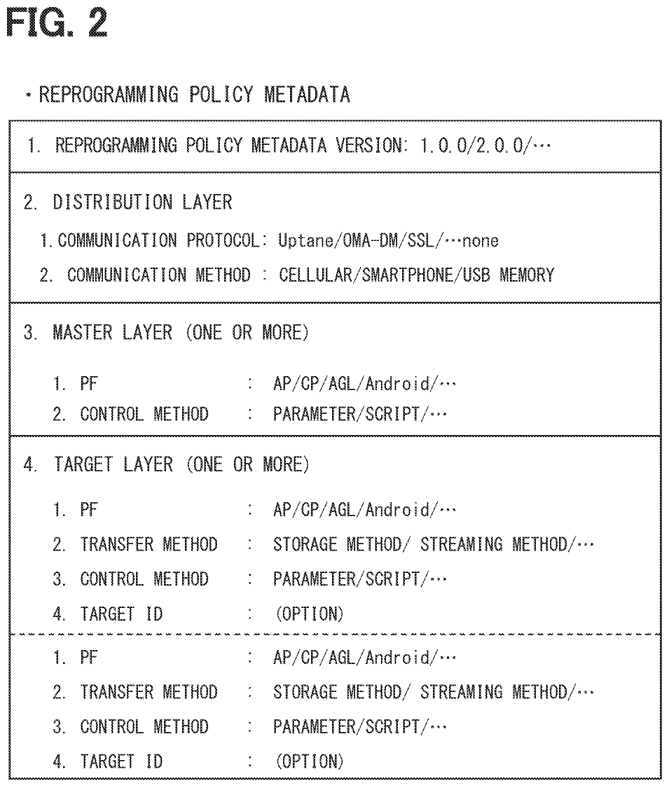

The reprogramming policy metadata illustrated in FIG. 2 is transmitted from the OTA center 2 to the OTA master 21 prior to the data download.

<Reprogramming Policy Metadata Version>

The reprogramming policy metadata version provides the version of reprogramming policy metadata. For example, the version information such as “1.0.0” or “2.0.0” is stored.

<Distribution Layer>

The distribution layer stores information on the protocol used to communicate with the OTA center 2 such as Uptane (registered trademark) or OMA-DM (Open Mobile Alliance-Device Management), “cellular” indicating the OTA master 21 as a communication method, and other information such as a smartphone or USB memory to be described later. Incidentally, the smartphone is an example of a portable information terminal.

<Master Layer>

The master layer stores information on the OTA master 21 whose platform (PF) is AP, CP, AGL (Automotive Grade Linux), or Android (registered trademark), for example. The specifications according to the general incorporated association JASPAR specify the data requirements applicable to the classic platform (CP) running on the static OS according to the standardizing body AUTOSAR in terms of the package structure to distribute update programs appropriate for the ECU platforms. AUTOSAR specifies the data requirements applicable to a new type of adaptive platform (AP) running on a dynamic OS. AGL represents an onboard Linux (registered trademark). Android represents Android Automotive OS.

Moreover, the master layer stores information on the control manner such as “parameter” for processing according to parameters set according to a specific format or “script” for processing based on a freer description format without the use of a specific format, for example.

<Target Layer>

This information corresponds to the target ECU22. The PF, the transfer manner, and the control manner conform to those described above. The target ID represents an ID corresponding to the target ECU 22 and is stored as an option.

<<Download Metadata>>

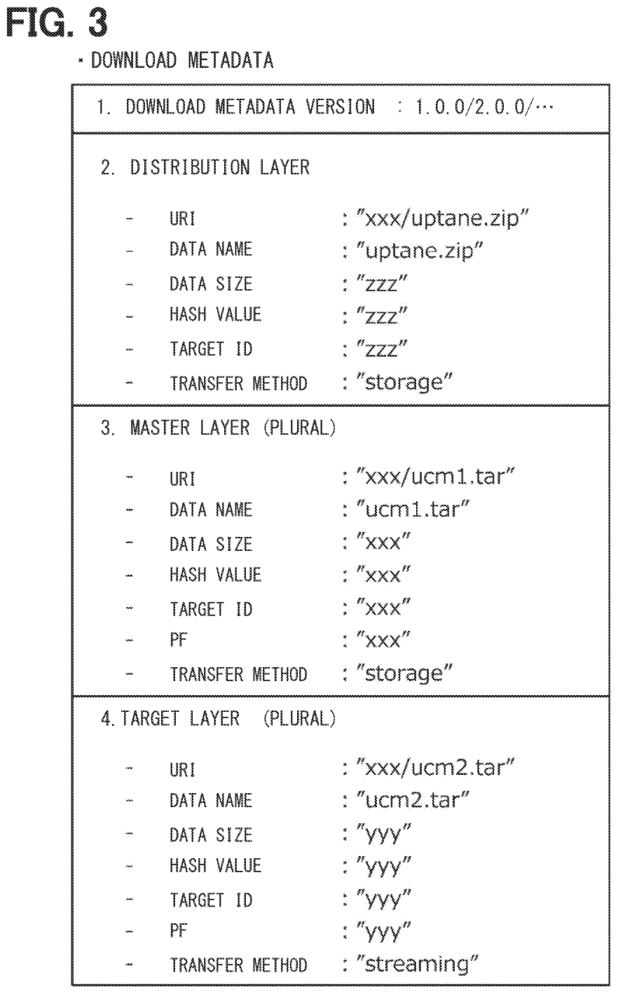

The download metadata illustrated in FIG. 3 is transmitted from the OTA center 2 to the OTA master 21 following the reprogramming policy metadata.

<Distribution Layer>

When the communication protocol is Uptane, for example, the distribution layer provides information to acquire Uptane metadata and stores the corresponding URI, data name, data size, hash value, target ID, and transfer manner, for example.

<Master Layer>

The master layer provides information to acquire Vehicle PKG, for example, and stores the same items as the distribution layer. Multiple master layers may be available.

<Target Layer>

The master layer provides information to acquire Software PKG, for example, and stores the same items as the distribution layer. Multiple master layers may be also available. Vehicle PKG and Software PKG are described on pages 50, 52, and 53 of “Specification of Update Configuration Management AUTOSAR AP R20-11, Document ID No. 706,” for example. Refer to the related description in the document.

The description below explains the differences between AP and CP. AP and CP represent software platforms. The software platform is also called a software architecture. CP stands for AUTOSAR Classic Platform. AP stands for AUTOSAR Adaptive Platform. ECUs that operate based on the CP specifications may be referred to as CP ECUs or CP's ECUs. ECUs that operate based on the AP specifications may be referred to as AP ECUs or AP's ECUs.

AP and CP differ in operating systems (OSs) or development languages used. CP ECU and AP ECU differ in the structures of receivable packages. The difference in the package structures mainly originates from the difference in ECU processing performances. Generally, CP ECU indicates low processing performance. The specification data contained in the package is also written in binary. The package data structure is easy to interpret and process even on ECUs with low processing performance.

Contrastingly, AP ECUs indicate high processing performance, making it possible to install a parser function that analyzes structural character data written in some language and converts the data into a program-friendly data structure. The data structure can use an object-oriented data format such as JSON (JavaScript Object Notation) instead of simple binary data. The package data structure is flexible.

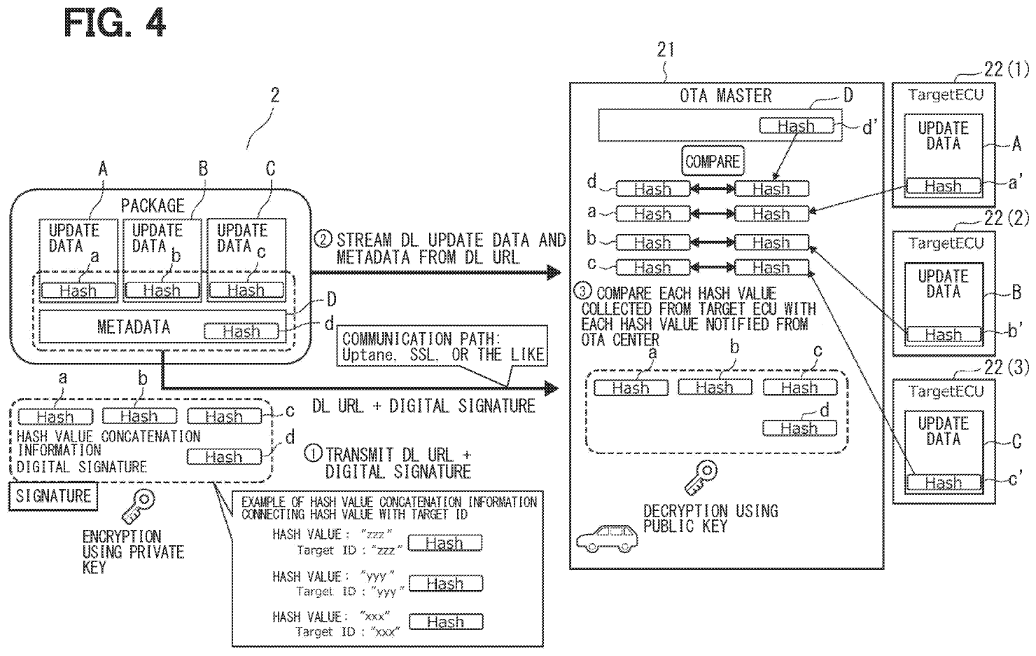

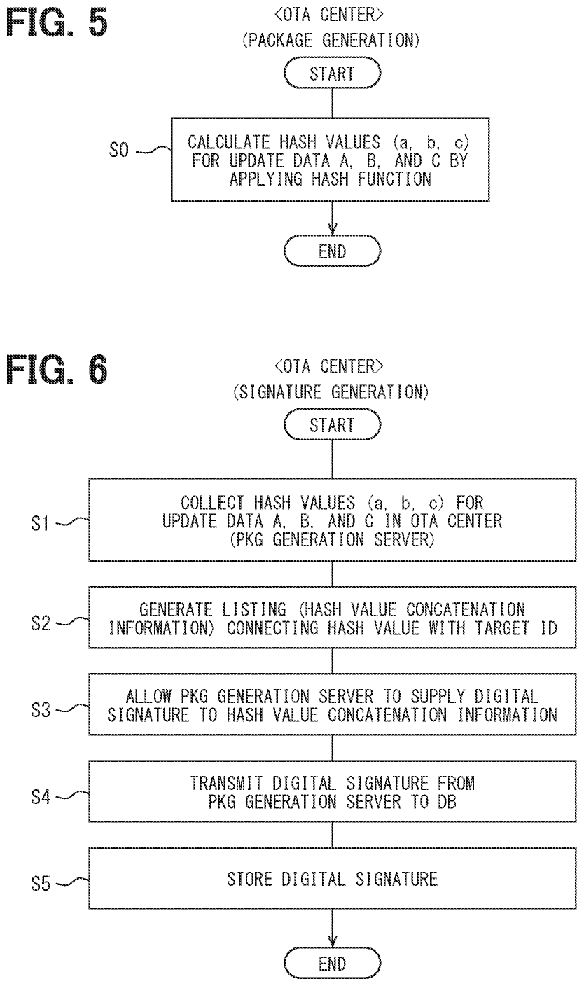

The description below explains the operations of the present embodiment. FIG. 4 conceptually illustrates the operations of the present embodiment. Suppose update data A through C correspond to target ECUs 22 (1) through 22 (3). Then, the distribution server 4 of the OTA center 2 allows the hash value calculation portion 11 to calculate hash values a through c for update data A through C by applying a hash function such as SHA (Secure Hush Algorithm)-2 (S0 in FIG. 5), for example. Hash value d is also similarly calculated for download metadata D. The flowcharts in FIGS. 4 to 9 only illustrate processes concerning hash values a through c.

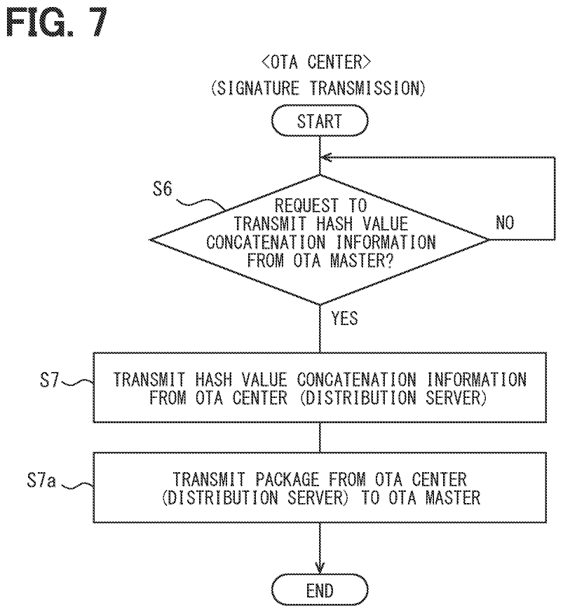

The hash value collection portion 10 collects hash values a through c (S1 in FIG. 6) to generate hash value concatenation information that connects these hash values a through c with the target ID (S2). The digital signature generation portion 12 generates and supplies a digital signature to the hash value concatenation information (S3) for encryption through the use of a private key. The digital signature is transmitted to and stored in the digital signature DB 102 (S4, S5). The OTA master 21 may thereafter request to transmit the hash value concatenation information (S6: YES in FIG. 7). Then, the distribution server 5 successively transmits the hash value concatenation information and the distribution package to the OTA master 21 (S7, S7a).

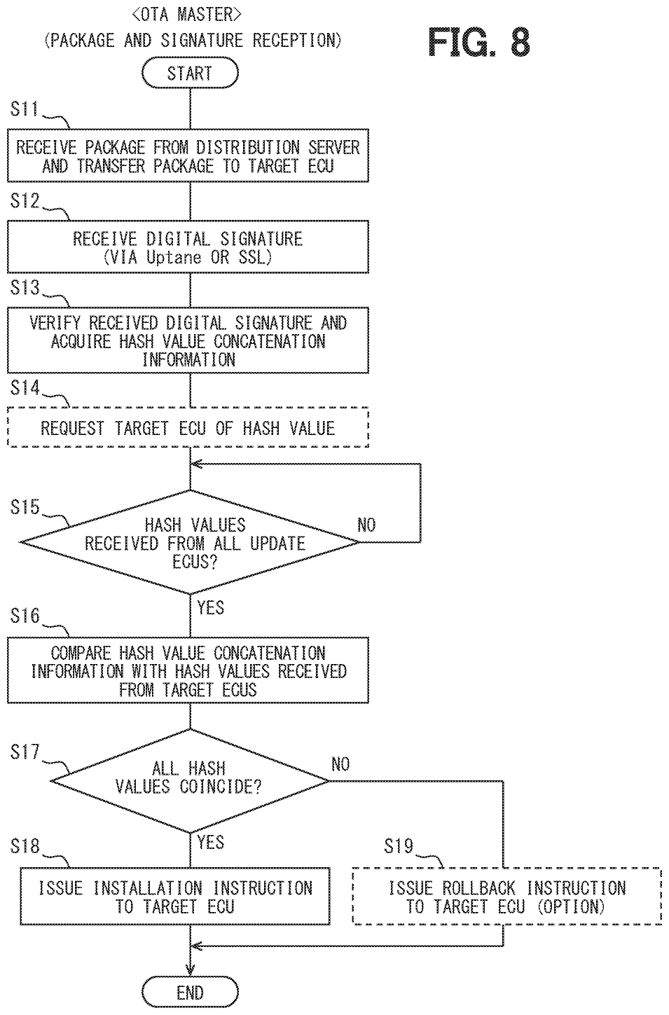

The description below explains processes on the vehicle-side system 3. As illustrated in FIG. 8, the download processing portion 23 of the OTA master 21 receives the streamed distribution package from the distribution server 5 and transfers update data A through C to the target ECUs 22 (1) through 22 (3) (S11). Then, the download processing portion 23 receives the digital signature (S12). The communication protocol in this case uses encryption such as Uptane or SSL (Secure Sockets Layer).

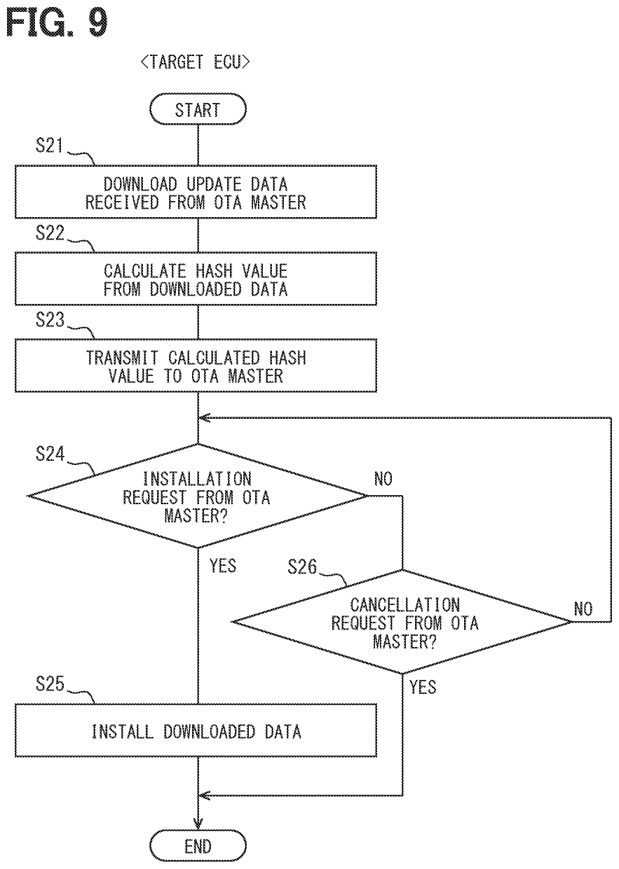

As illustrated in FIG. 9, the target ECU 22 downloads the update data received from the OTA master 21 (S21) and applies the hash function to the update data to calculate the hash value (S22). The calculated hash value is transmitted to the OTA master 21 (S23).

The OTA master 21 verifies the received digital signature by using a public key for decryption and acquires the hash value concatenation information (S13). The target ECUs 22 (1) through 22 (3) are requested to transfer hash values (S14). However, this process is unnecessary if the target ECU 22 is specified to automatically transfer hash values to the OTA master 21 at step S23.

Hash values a′ through c′ may be received from all the target ECUs 22 (S15; YES). Then, the hash value comparison portion 26 compares the hash values a through c acquired from the hash value concatenation information with the hash values a′ through c′ acquired from the target ECU 22 (S16). If all the hash values coincide with each other (S17; YES), an installation instruction is issued to the target ECUs 22 (1) through 22 (3) (S18). If a difference is found (S17; NO), a rollback instruction is issued to the different target ECU 22 (S19). This process is optional.

The installation may be requested from the OTA master 21 (S24; YES). Then, the target ECU 22 installs the downloaded update data (S25). No installation may be requested (S24; NO) and a cancellation may be requested from the OTA master 21 (S26; YES). Then, the process terminates.

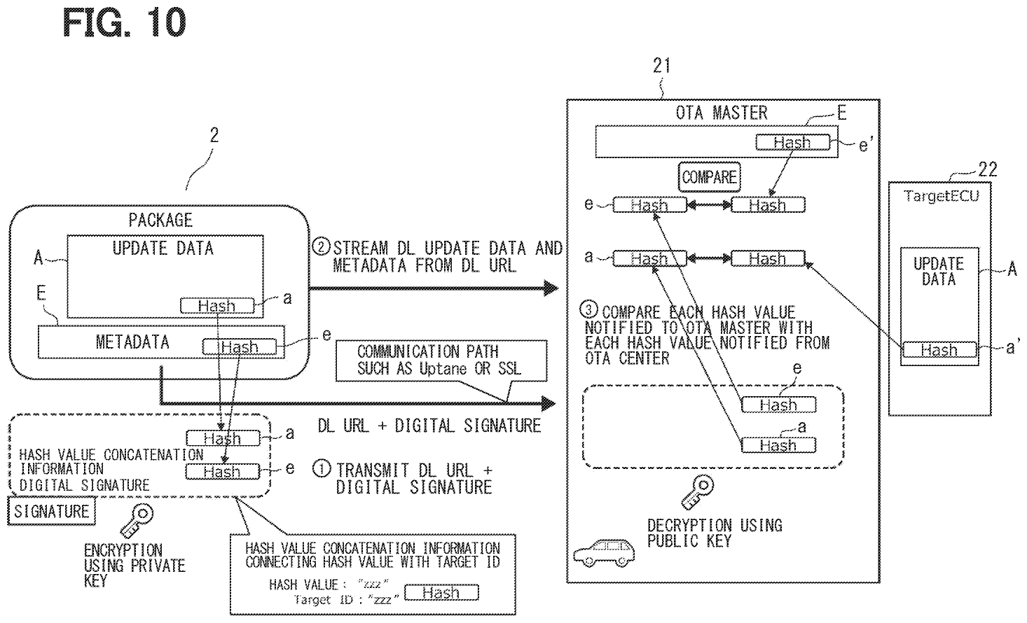

The above-described process applies to the multiple target ECUs 22. FIG. 10 illustrates a process applied to the single target ECU 22. The process is basically equal to that illustrated in FIG. 4 except that metadata E corresponds to hash value e.

In the onboard communication system 1 according to the present embodiment, the OTA center 2 transmits the distribution package in a streaming manner to the OTA master 21 on the vehicle and also transmits the hash value calculated based on the update data to the OTA master 21. The OTA master 21 receives the distribution package and then transfers the update data to the target ECU 22. The target ECU 22 calculates a hash value based on the update data and then transmits the hash value to the OTA master 21. The OTA master 21 verifies the integrity of the update data by comparing the hash value transmitted from the OTA center 2 with the hash value transmitted from the target ECU 22.

According to this configuration, the OTA master 21 performs verification using hash values even if the update data contained in the distribution package streamed from the OTA center 2 to the vehicle-side system 3 may be falsified and changed to incomplete data, for example. It is possible to prevent incomplete update data from being installed on the target ECU 22. It is possible to improve the security of communication system 1.

Update data A through C may be written to the multiple target ECUs 22 (1) through 22 (3), respectively. In this case, the OTA center 2 also transmits the hash values a through c calculated for update data A through C to the OTA master 21. The OTA master 21 transfers update data A through C to the target ECUs 22 (1) through 22 (3) respectively. The target ECUs 22 (1) through 22 (3) calculate hash values a′ through c′ for update data A through C and transmit the hash values a′ through c′ to the OTA master 21. The OTA master 21 compares the hash values a′ through c′ with the hash values a through c. It is also possible to prevent incomplete update data from being installed when update data A through C are transmitted to the multiple target ECUs 22 (1) through 22 (3).

### Second Embodiment

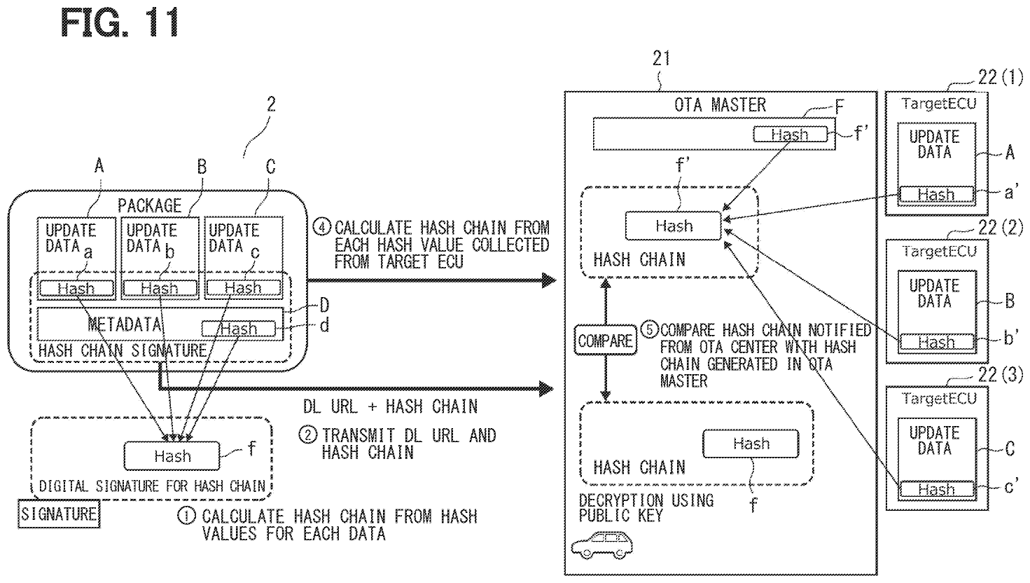

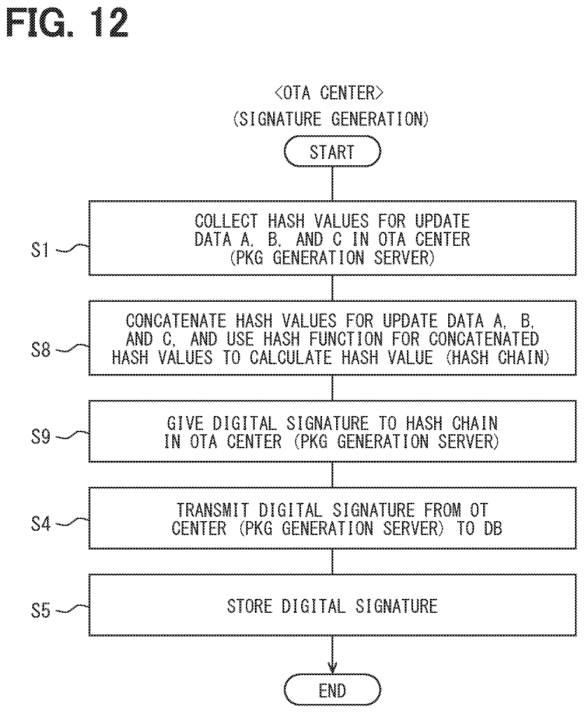

The mutually corresponding parts in the second and first embodiments are designated by the same reference numerals and a detailed description is omitted for simplicity. The following describes differences from the first embodiment. According to the second embodiment, as illustrated in FIG. 11, the PKG generation server 4 applies the hash function to hash values a through c acquired corresponding to update data A through C and hash value d acquired corresponding to the metadata. The acquired hash value f is referred to as a “hash chain” (S8 in FIG. 12). Hash chain f corresponds to a high-order hash value. A digital signature is given to hash chain f (S9) and then steps S4 and S5 follow.

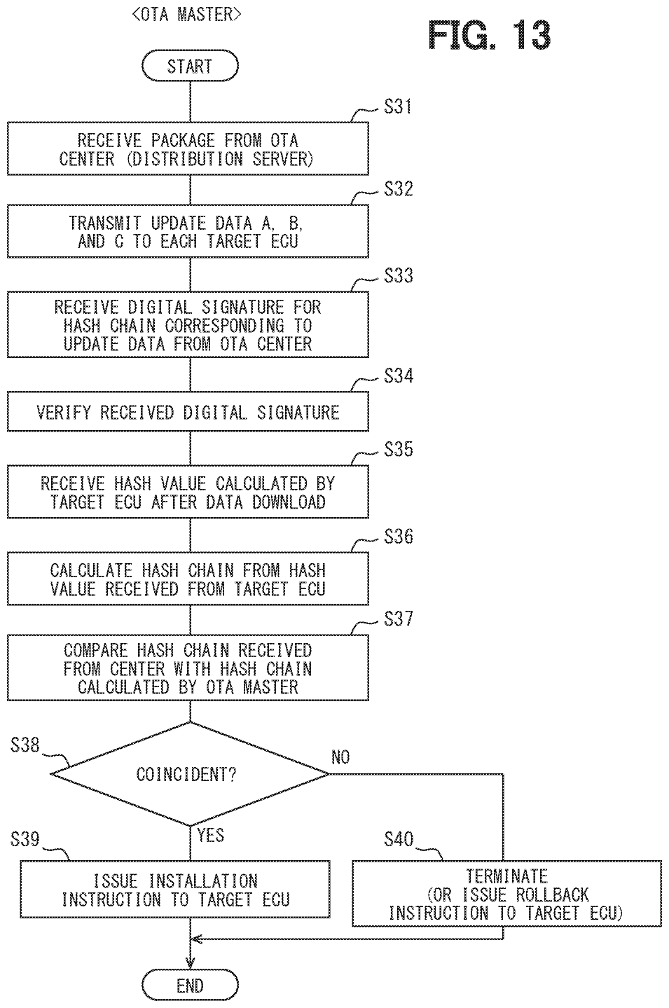

The OTA master 21 receives the distribution package from the distribution server 5 of the OTA center 2 (S31 in FIG. 13) and then transfers update data A through C to the target ECUs 22 (1) through 22 (3) (S32). The process performed by the target ECU 22 is similar to that illustrated in FIG. 9.

The download processing portion 23 receives the digital signature given to hash chain f (S33) and verifies the received digital signature (S34). A successful verification provides hash chain f.

The OTA master 21 receives hash values a′ through c′ calculated by the target ECUs 22 (1) through 22 (3) (S35). The hash value calculation portion 11 calculates hash chain f′ for the received hash values a′ through c′ (and d′) (S36).

The hash value comparison portion 26 compares hash chain f acquired from the OTA center 2 with hash chain f′ calculated by the hash value calculation portion 11 (S37). If both coincide (S38; YES), an installation instruction is issued to the target ECUs 22 (1) through 22 (3) (S18). If a difference is found (S38; NO), the process terminates or a rollback instruction is issued to the target ECU 22 (S40).

According to the second embodiment as above, the OTA center 2 also transmits hash chain f, namely, a hash value calculated in terms of multiple hash values a through c, to the OTA master 21. The OTA master 21 calculates hash chain f′ in terms of hash values a′ through c′ received from the ECU 22 (1) through 22 (3) and then compares hash chain f′ with hash chain f. The verification can detect incomplete data, if any, in hash values a through c, making it possible to further improve the security of the communication system.

### Third Embodiment

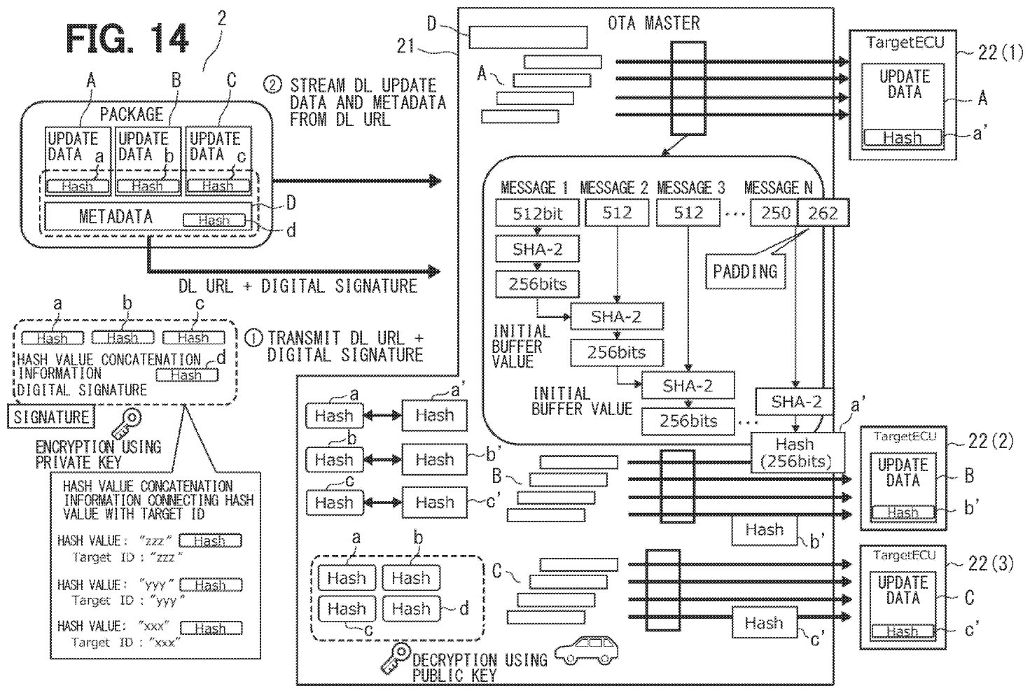

According to the third embodiment, as illustrated in FIG. 14, the OTA master 21 sequentially calculates hash values for update data while receiving the distribution packages from the OTA center 2 in streaming mode. The above-described SHA-2 is used as a hash function. The description below explains examples using the SHA-2 function. The process on the OTA center 2 is similar to that illustrated in FIG. 5. The OTA master 21 identifies the size of data to be received based on the download metadata received from the OTA center 2 (S41 in FIG. 15). Then, the OTA master 21 calculates how many times the data size is multiplied by 512 bits (S42), and then receives the distribution package in a streaming manner from the OTA center 2 (S43).

The OTA master 21 divides the received data in units of 512 bits (S44). The divided data is referred to as a “message.” Suppose the received data is divided into N messages, for example. The hash value calculation portion 25 applies the SHA-2 function to the messages (S45) and keeps the output result as an initial buffer value for the next SHA-2 function (S46). For example, SHA-256 is applied to 512-bit data to generate a hash value whose hash length is 256 bits. The process at steps S45 and S46 is repeated until the SHA-2 function is applied to (N−1) messages (S47; NO).

If the N-th message is reached (S47; YES), the process determines whether the data size is an integral multiple of 512 bits (S48). If the data size is not the integral multiple (NO), the process generates the integral multiple by padding and then applies the SHA-2 function. The output result is used as a hash value (S49). The OTA master 21 verifies the digital signature received from the distribution server 4 and acquires the hash value (S50). At step S48, the message data size may be an integral multiple of 512 bits (YES). In this case, the final hash value is acquired. Then, control proceeds to step S50.

The hash value comparison portion 26 compares the hash value acquired at step S50 with the hash value calculated by the hash value calculation portion 25 (S51). If both coincide (S52; YES), an installation instruction is issued to the target ECU 22 (S53). If a difference is found (S52; NO), the process terminates or a rollback instruction is issued to the target ECU 22 (S54).

The process illustrated in FIG. 15 corresponds to one target ECU 22 and is repeatedly performed for multiple target ECUs 22. The process for the target ECU 22 illustrated in FIG. 16 performs only steps S21, S24, and S25 in FIG. 9 and terminates If “NO” is determined at step S24.

According to the third embodiment as above, the OTA master 21 calculates a hash value for each update data based on a predetermined data size and thereby acquires a hash value for the entire update data. The OTA master 21 compares the hash value with the hash value transmitted from the OTA center 2 to verify the integrity of the update data. The above-described configuration can perform the integrity verification as a process inside the OTA master 21.

### Fourth Embodiment

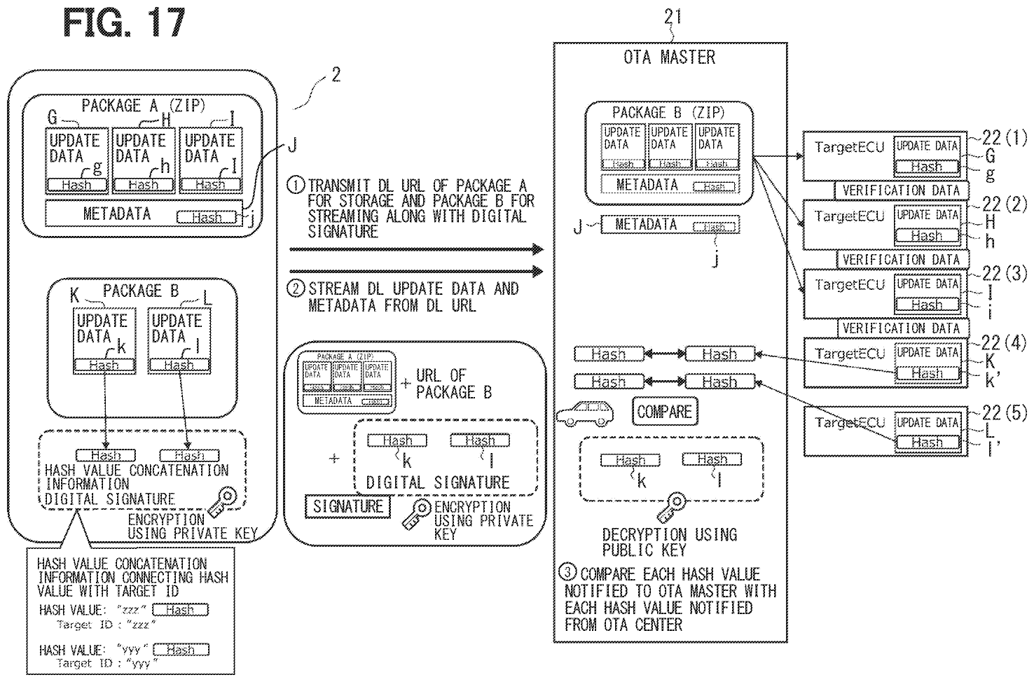

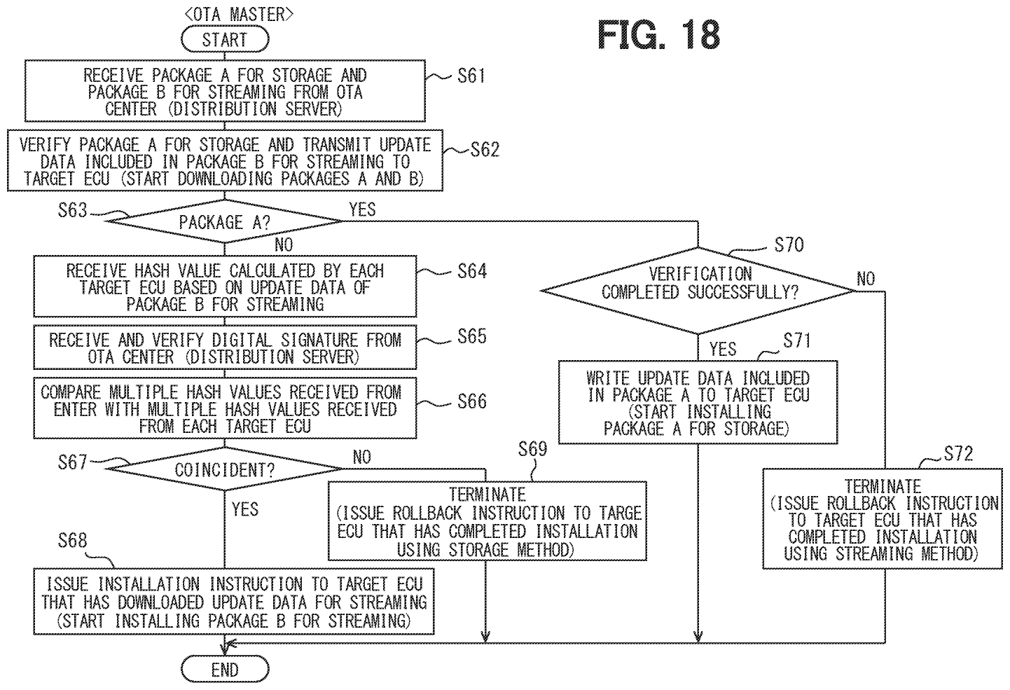

As illustrated in FIG. 17, the fourth embodiment provides the process as a mixture of the streaming manner and the storage manner. The process on the OTA center 2 is similar to First Embodiment. As illustrated in FIG. 18, The OTA master 21 receives storage type package A based on the storage manner and package B based on the streaming manner from the distribution server 5 (S61). Package A conforms to the zip format and contains validation data about package A. The OTA master 21 then verifies package A using the verification data and transmits update data K and L contained in package B to the target ECUs 22 (4) and 22 (5) (S62). Then, packages A and B start to be downloaded.

Package A may be identified (S63; YES) and the verification may normally terminate (S70; YES). Then, update data G through I contained in package A are written to the target ECUs 22 (1) through 22 (3) (S71). Package A starts to be installed. If the verification does not terminate normally (S70; NO), the process on package A terminates. A rollback instruction is issued to the target ECU 22 that has started to install package B (S72).

If package B is identified (S63; NO), the OTA master 21 receives hash values k′ and I′ calculated by the target ECUs 22 (4) and 22 (5) for update data K and L (S64). The process by the target ECU 22 is similar to that illustrated in FIG. 9. The verification is performed when the digital signature is received from the distribution server 5 (S65).

The process compares decrypted hash values k and I with hash values k′ and I′ (S66). If both coincide (S67; YES), an installation instruction is issued to the target ECUs 22 (4) and 22 (5) (S68). Package B starts to be installed. If both differ from each other (S67; NO), the process for package B terminates. A rollback instruction is issued to the target ECU 22 that has started to install package A (S69).

The description below explains another mode of FIG. 18. The above-described embodiment determines at S63 whether the package is package A. Instead, the OTA master 21 may determine the type of package and perform a process according to the result. Upon reception of packages A and B, the OTA master 21 determines the package type. When it is determined that the package conforms to package A based on the storage manner, the OTA master 21 proceeds to S70 and performs the process from S70 to S72. When it is determined that the package conforms to package B based on the streaming manner, the OTA master 21 proceeds to S64 and performs the process from S64 to S69. The OTA master 21 repeats the determination of the package type as many times as the number of received packages.

According to the fourth embodiment as above, the OTA center 2 transmits update data to be written to some of the multiple target ECUs 22 according to the storage manner while transmitting the update data and the hash value calculated for the data to the OTA master 21. The OTA master 21 calculates a hash value for the update data and compares it with the corresponding hash value transmitted from the OTA center 2 to verify the integrity of the update data. When the integrity is verified, the update data is transferred to the target ECUs 22 (1) through 22 (3) corresponding to the storage manner. The security can be improved even if some target ECUs 22 correspond to the storage manner.

### Fifth Embodiment

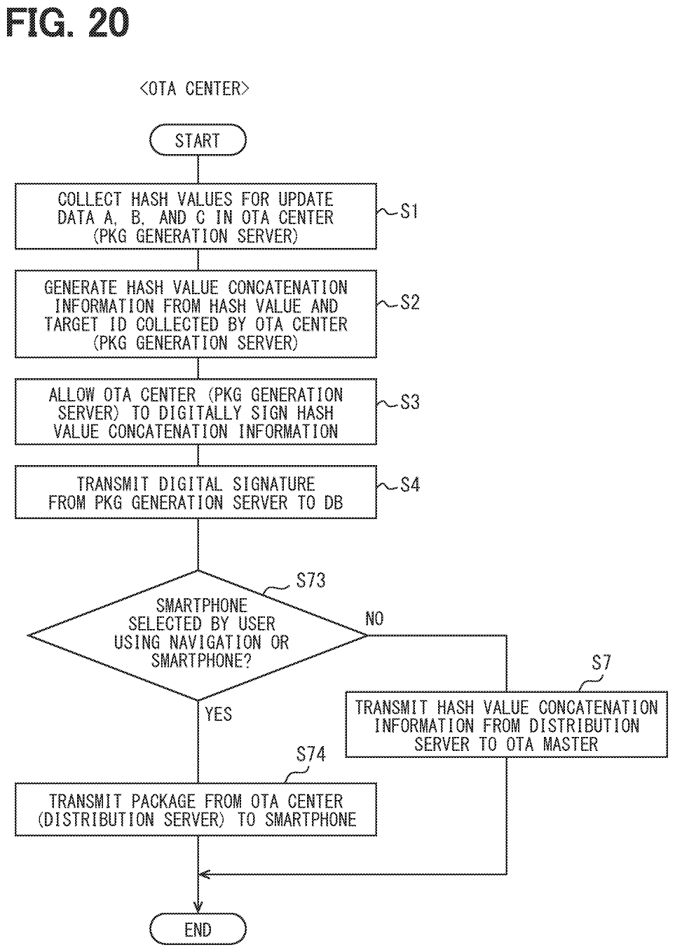

As illustrated in FIG. 19, the fifth embodiment illustrates a case where a distribution package is once downloaded from the OTA center 2 to a smartphone 31 and then transferred from the smartphone 31 to the OTA master 21. The “smartphone” may be denoted as a “smartphone” and a car navigation system may be denoted as a “navi.” As illustrated in FIG. 20, the OTA center 2 performs steps S1 through S4 and then determines whether the smartphone 31 is selected as a package delivery destination (S73). As explained below, the user communicates with the OTA center 2 using a car navigation system (unshown) or the smartphone 31. If the smartphone 31 is selected (YES), the package is distributed to the smartphone 31 (S74). If the smartphone 31 is not selected (NO), the package is distributed to the OTA master 21 (S7) as above.

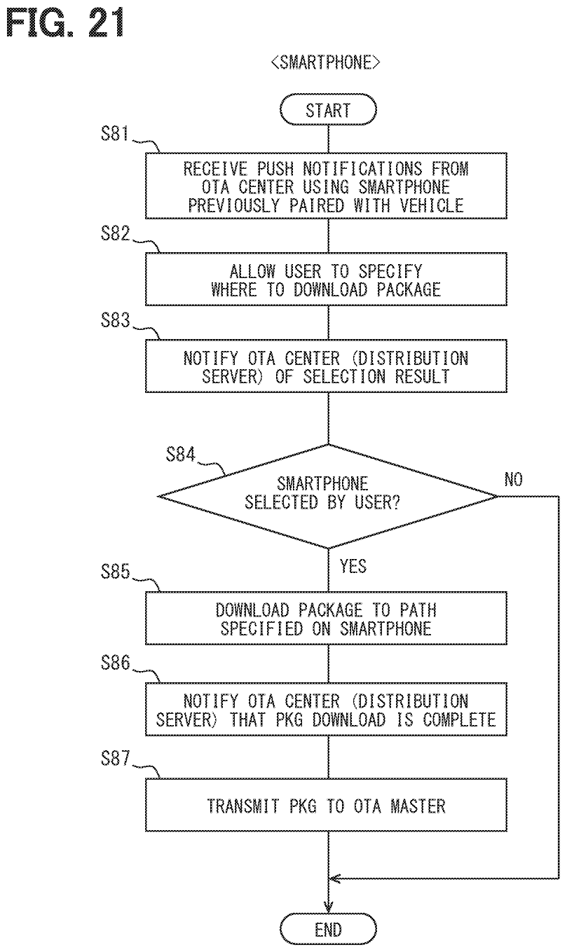

As illustrated in FIG. 21, the user carrying the smartphone 31 receives a push notification from the OTA center 2 (S81) under the condition that the smartphone 31 and a device on the vehicle are paired based on wireless communication. Using the smartphone 31, the user selects where to download the distribution package (S82). The selection result is notified to the distribution server 5 of the OTA center 2 (S83).

If the user selects the smartphone 31 (S84; YES), the package is downloaded (DL) to a specified path on the smartphone 31 (S85). The smartphone 31 notifies the completion of the package download to the distribution server 5 (S86) and then transfers the package to the OTA master 21 (S87).

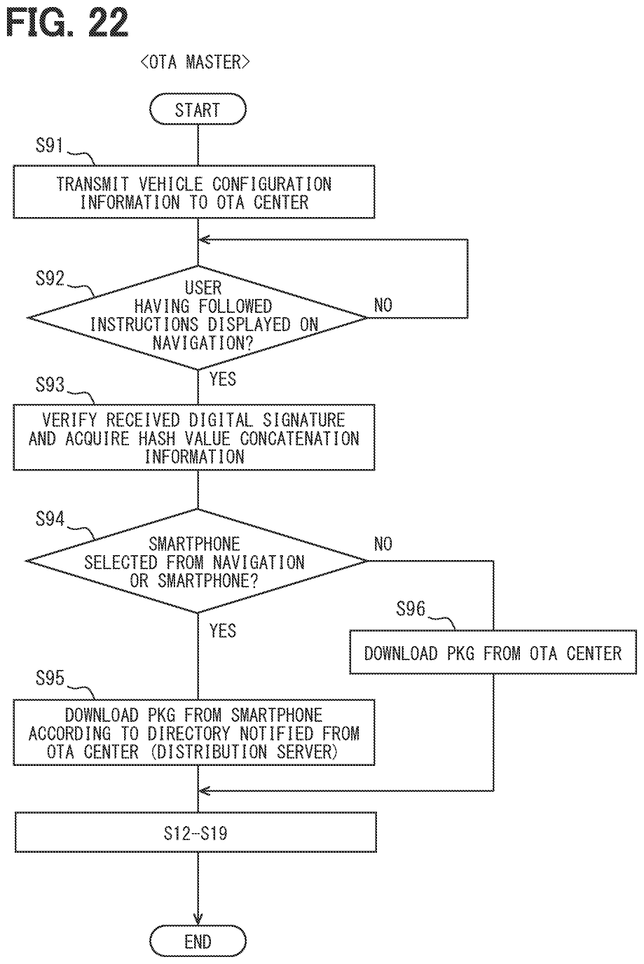

As illustrated in FIG. 22, the OTA master 21 transmits vehicle configuration information to the OTA center 2 (S91) to synchronize the OTA center 2 with the vehicle configuration information. If the user performs an instruction displayed on the car navigation system (S92; YES), the OTA master 21 verifies the digital signature received from the OTA center 2 and acquires the hash value concatenation information (S93).

The car navigation system or the smartphone 31 may notify the OTA center 2 that the smartphone 31 is selected as the distribution package transmission destination (S94; YES). Then, the OTA master 21 downloads the distribution package from the smartphone 31 according to the directory notified from the OTA center 2 (S95). If the smartphone 31 is not selected as the transmission destination (S94; NO), the OTA master 21 downloads the distribution package from the OTA center 2 (S96). The process thereafter performs steps S12 through S19 according to the first embodiment.

According to the fifth embodiment as above, the OTA master 21 can selectively download the distribution packages from the smartphone 31 after the distribution packages are downloaded from the OTA center 2 to the smartphone 31. Distribution packages can be acquired more flexibly.

### OTHER EMBODIMENTS

The contents of the reprogramming policy metadata and the download metadata may be modified as appropriate according to individual designs.

The hash function is not limited to SHA-2.

The present disclosure has been described in accordance with embodiments but the present disclosure is not limited to those embodiments or structures. The present disclosure also includes various modifications and modifications within an equivalent range. In addition, various combinations and modes and other combinations and modes obtained by adding only one element or more or less element to the combinations and modes are also included in the categories and technical scope of the present disclosure.

Means and/or functions provided by each device or the like may be provided by software recorded in a substantive memory device and a computer that can execute the software, software only, hardware only, or some combination of them. For example, if the control device is provided by an electronic circuit that is hardware, the control device may be provided by a digital circuit or an analog circuit that includes a large number of logic circuits.

The control unit and method described in the present disclosure may be implemented by a dedicated computer which is configured with a memory and a processor programmed to execute one or more particular functions embodied in computer programs of the memory. Alternatively, the control unit and the method described in the present disclosure may be implemented by a dedicated computer provided by forming a processor with one or more dedicated hardware logic circuits. Alternatively, the control unit and the method described in the present disclosure may be implemented by one or more dedicated computers including a combination of a processor and a memory programmed to execute one or multiple functions and a processor including one or more hardware logic circuits. Furthermore, the computer program may be stored in a computer-readable non-transition tangible recording medium as an instruction executed by a computer.

What is claimed is:

1. An onboard communication system comprising:
a center device that is configured to transmit update data as a distribution package by a streaming manner to an electronic control unit installed in a vehicle;
a master device that is installed in the vehicle and is configured to receive the distribution package and transfer the update data to the electronic control unit; and
the electronic control unit that is configured to write the update data transferred from the master device to a storage unit,
wherein
the center device also transmits a hash value calculated for the update data to the master device,
the electronic control unit calculates a hash value for the update data and transmits the hash value to the master device, and
the master device compares the hash value transmitted from the center device with the hash value transmitted from the electronic control unit to verify integrity of the update data.

2. The onboard communication system according to claim 1, wherein
the center device transmits a plurality of hash values calculated for each update data to the master device when a plurality of update data is respectively written to a plurality of electronic control units,
the master device transfers each of the update data to each of the electronic control units,
each of the electronic control units calculates a hash value for the update data and transmits the hash value to the master device, and
the master device compares each of the hash values transmitted from the electronic control units with the corresponding hash value transmitted from the center device.

3. The onboard communication system according to claim 2, wherein
a hash value calculated for the plurality of hash values is defined as a high-order hash value,
the center device also transmits the high-order hash value to the master device, and
the master device calculates a high-order hash value for the hash values received from the electronic control units, and compares the calculated high-order hash value with the high-order hash value transmitted from the center device.

4. The onboard communication system according to claim 2, wherein
when update data is transmitted to a part of the plurality of electronic control units in a storage manner, the center device transmits the update data and the hash value calculated for the update data to the master device,
the master device calculates a hash value for the update data and compares the calculated hash value with the corresponding hash value transmitted from the center device to verify integrity of the update data, and
when the integrity of the update data is verified, the master device transfers the update data to an electronic control unit supporting the storage manner.

5. The onboard communication system according to claim 1, wherein
the center device adds the hash value to download metadata including at least an address of a data acquisition destination, a data name, a data size, an ID of an electronic control unit to which the update data is distributed, and information of a data transfer manner, and transmits to the master device.

6. The onboard communication system according to claim 1, further comprising:
a portable information terminal capable of receiving the update data from the center device,
wherein
the master device is able to receive the update data via the portable information terminal.

7. An onboard communication system comprising:
a center device that is configured to transmit update data as a distribution package by a streaming manner to an electronic control unit installed in a vehicle;
a master device that is configured to receive the distribution package and transfer the update data to the electronic control unit; and
the electronic control unit that is configured to write the update data transferred from the master device to a storage unit,
wherein
the center device also transmits a hash value calculated for the update data to the master device, and
the master device calculates a hash value for each predetermined data size for the update data to obtain a hash value for a whole update data, and compares the hash value with the hash value transmitted from the center device to verify integrity of the update data.

8. A center device that transmits update data by a streaming manner as well as a hash value calculated for the update data to an electronic control unit installed in a vehicle.

9. The center device according to claim 8, wherein
when transmitting the update data to each of a plurality of electronic control units, the center device also transmits a plurality of hash values calculated for each update data.

10. The center device according to claim 9, wherein
the hash value calculated for the plurality of hash values is defined as a high-order hash value, and
the high-order hash value is also transmitted.

11. The center device according to claim 9, wherein
when the update data is transmitted by a storage manner for a part of the plurality of electronic control units, the center device transmits the update data and the hash value calculated for the update data.

12. The center device according to claim 8, wherein
the center device adds a hash value to at least an address of a data acquisition destination, a data name, a data size, an ID of an electronic control unit to which the update data is distributed, and information of a data transfer manner and transmit them.

13. A vehicle-side system comprising:
a master device that is installed in a vehicle and is configured to receive a distribution package, which includes update data and is transmitted from a center device by a streaming manner; and
an electronic control unit that is installed in the vehicle and is configured to write the update data transferred from the master device to a storage portion,
wherein
the master device receives a hash value calculated for the update data and transmitted by the center device,
the electronic control unit calculates a hash value for the update data and transmits the hash value to the master device, and
the master device compares the hash value transmitted from the center device with the hash value transmitted from the electronic control unit to verify integrity of the update data.

14. The vehicle-side system according to claim 13, wherein
when the center device transmits a plurality of update data to a plurality of electronic control units, the master device also receives a plurality of hash values calculated and transmitted for each of the update data and transfers each update data to each electronic control unit,
each of the electronic control units calculates a hash value for the update data and transmits the hash value to the master device, and
the master device compares the hash values transmitted from the plurality of electronic control units with the corresponding hash values transmitted from the center device.

15. The vehicle-side system according to claim 14, wherein
the master device also receives a hash value that is calculated and transmitted by the center device for the hash values as a high-order hash value, and
when the master device calculates a high-order hash value for the plurality of hash values received from the plurality of electronic control units, the master device compares the calculated high-order hash value with the high-order hash value transmitted from the center device.

16. The vehicle-side system according to claim 14, wherein
when the center device transmits a distribution package including the update data for a part of the plurality of electronic control units in a storage manner, the master device receives the update data and a hash value calculated for the update data,
the master device calculates a hash value for the update data and compares the calculated hash value with the corresponding hash value transmitted from the center device to verify integrity of the update data, and
when the integrity of the update data is verified, the master device transfers the update data to an electronic control unit supporting the storage manner.

17. The vehicle-side system according to claim 13, further comprising:
a portable information terminal capable of receiving the distribution package from the center device,
wherein
the master device is able to receive the distribution package from the center device via the portable information terminal.

18. A vehicle-side system comprising:
a master device that is installed in a vehicle and is configured to receive update data transmitted by a streaming manner from a center device as a distribution package; and
an electronic control unit that is installed in the vehicle and is configured to write the update data transferred from the master device to a storage portion,
wherein
the center device transmits a hash value calculated for the update data to the master device, and
the master device receives a hash value calculated for the update data by the center device, calculates a hash value for each predetermined data size for the update data to obtain a hash value for a whole update data, and compares the hash value with the hash value transmitted from the center device to verify integrity of the update data.

19. A method for verifying update data of onboard communication comprising:
when a center device transmits update data by a streaming manner to an electronic control unit installed in a vehicle,
transferring distribution package to the electronic control unit when a master device installed in the vehicle receives the update data as the distribution package;
transmitting, by the center device, a hash value calculated for the update data to the master device,
transmitting, by the electronic control unit, a hash value calculated for the update data to the master device, and
verifying, by the master device, integrity of the update data by comparing the hash value transmitted from the center device with the hash value transmitted from the electronic control unit.

20. A method for verifying update data of onboard communication comprising,
when a center device transmits update data by a streaming manner to an electronic control unit installed in a vehicle,
transferring a distribution package to the electronic control unit when a master device installed in the vehicle receives the update data as the distribution package,
transmitting, by the center device, a hash value calculated for the update data to the master device,
receiving, by the master device, a hash value for the update data calculated by the center device,
obtaining, by the master device, a hash value for a whole update data by calculating a hash value for each predetermined data size for the update data, and
verifying, by the master device, integrity of the update data by comparing the hash value with the hash value transmitted from the center device.
